(19) United States
(12) Patent Application Publication
(10) Pub. No.: US 2014/0245849 A1
(43) Pub. Date: Sep. 4, 2014

(54) FOOT PEDAL-ACTUATED CABLE

(71) Applicant: FOX RUN BRANDS, Ivyland, PA (US)

(72) Inventors: Louis F. HENRY, Scarsdale, NY (US); Chris MELLEN, New York, NY (US)

(73) Assignee: FOX RUN BRANDS, Ivyland, PA (US)

(21) Appl. No.: 14/194,494

(22) Filed: Feb. 28, 2014

Related U.S. Application Data
(60) Provisional application No. 61/771,776, filed on Mar. 1, 2013.

(51) Int. Cl. F16C 1/12; G05G 1/46; G05G 1/44

(52) U.S. Cl. CPC F16C 1/12; G05G 1/44; G05G 1/46
USPC 74/108

(57) ABSTRACT

The dispensing system of the present disclosure provides a convenient way for a user to dispense product onto a workpiece, food product, or similar item. A foot pedal can be connected to one end of a cable, and a plunger can be connected to a second end of the cable. The plunger can have two members or levers that compress toward each other when the user steps on the pedal, drawing the cable taut.

### CROSS-REFERENCE TO RELATED APPLICATIONS

The present application claims the priority of U.S. Provisional Patent Application No. 61/771,776, filed on Mar. 1, 2013, which is herein incorporated by reference.

### BACKGROUND OF THE DISCLOSURE

1. Field of the Disclosure

The present disclosure relates to a foot pedal that can actuate a cable. More particularly, the present disclosure relates to a foot pedal that actuates a cable to close or release a plunger.

2. Background of the Disclosure

There is a continuing need fort hands-free operation of tools, but limited ways in which a user can operate a tool and still keep both hands free. The present disclosure addresses this need.

### SUMMARY OF THE DISCLOSURE

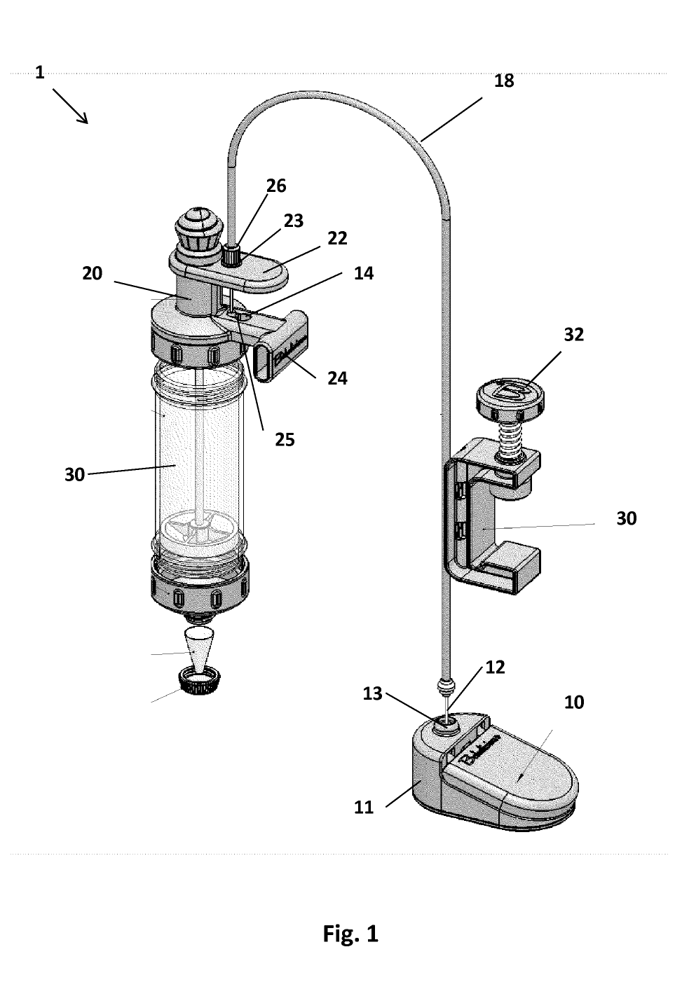

Referring to FIG. 1, dispenser 1 of the present disclosure is shown. Dispenser 1 has pedal 10, which is connected to one end 13 of cable 12. A second end 14 of cable 12 can be connected to a tool to be operated. In the shown embodiment, end 14 of cable 12 is connected to a plunger 20 that has dispenser level or paddle 22 and rigid lever 24. By depressing pedal 10, cable 12 is pulled taut, and in the manner described below, pulls paddle 22 and lever 24 together, which depresses plunger 20.

Thus, pedal 10 provides a very convenient dispensing device that allows a user to keep both hands free. All the user has to do is step on pedal 10, and move any object they are working with under plunger 20. In the shown embodiment, plunger 20 is connected to a gun 30 that can dispense a confectionary substance such as cake frosting. Thus, the user can dispense the frosting onto a cake for example, without having to use their hands to manipulate gun 30. Plunger 20 and gun 30 can be mounted on a tabletop, and the user can present the food product to gun 30 to be coated.

The present disclosure contemplates other types of dispensing operations and products. Dispenser 1 would be suitable for any operation where a hands-free dispensing operation is desired. For example, plunger 20 could be connected to a source of caulk, and dispense the caulk onto a workpiece.

Pedal 10 can be connected to housing 11, which can in turn store first end 13 of cable 12 therein. On plunger 20, second end 14 of cable 12 can be affixed to rigid plunger lever 24. Cable 12 also passes through a hole 23 in paddle 22. Nut 26 on paddle 22 connects cable 12 to paddle 22, so that when cable 12 is pulled taut, paddle 22 is drawn downward toward lever 24, depressing plunger 20.

In the shown embodiment, paddle 22, on top, moves, while lever 24, on bottom, stays stationary. However, the present disclosure contemplates other embodiments where both of paddle 22 and lever 24 move, or where paddle 22 is stationary and lever 24 moves in an upward direction. In addition, in the shown embodiment paddle 22 and lever 24 are substantially parallel to one another, and remain so during the movement of paddle 22. The present disclosure contemplates alternative embodiments where

Second end 14 of cable 12 can be permanently connected to lever 24. Alternatively, second end 14 can be removably connected. Lever 24 can have a slot 25 therein, and second end 14 can have a structure that mates with slot 25. To remove cable 12, a user removes second end 14 from slot 25, and loosens nut 26. Plunger 20 can then be operated independently of cable 12 and pedal 10. Cable 12 can also have protective sheath 18.

As is also shown in FIG. 1, dispenser 1 can have a clamp 30 that is affixed to cable 12 at a point along the length of cable 12. Clamp 30 can have an adjustable fastener 32. This allows the user to affix clamp 30 to a counter or other similar surface, providing additional stability when using dispenser 1.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

What is claimed is:

1. A dispensing system, comprising:
a foot pedal;
a cable having a first end and a second end, wherein said first end is connected to said foot pedal; and
a plunger having a first level and a second lever connected thereto, wherein said first lever and said second lever are in spaced parallel arrangement, wherein a second end of said cable is connected to first lever,
such that depressing said pedal draws said cable taut, thereby drawing said first lever and said second lever together, and depressing said plunger.

2. The dispensing system of claim 1, wherein said first lever is stationary.

3. The dispensing system of claim 1, wherein said cable passes through an opening on said second lever.

4. The dispensing system of claim 3, further comprising a nut for affixing said cable to said second lever.

5. The dispensing system of claim 1, wherein said second end of said cable is removably connected to said first lever.

6. The dispensing system of claim 1, further comprising a clamp affixed to said cable at a point between said first end and said second end.
